(19) United States
(12) Patent Application Publication
(10) Pub. No.: US 2025/0208254 A1
(43) Pub. Date: Jun. 26, 2025

(54) A SYSTEM FOR COMPRESSING REFLECTED SIGNALS ON A FLUCTUATING NOISE BACKGROUND IN ACTIVE SURVEILLANCE RADAR SYSTEMS

(71) Applicant: VIETTEL GROUP, Ha Noi City (VN)

(72) Inventors: QUOC HUNG LE, Ha Noi City (VN); TRAN SU LE, Ha Noi City (VN); NGOC VINH VU, Ha Noi City (VN); QUANG BANG NGUYEN, Ha Noi City (VN); VAN HOANG NGUYEN, Ha Noi City (VN)

(73) Assignee: VIETTEL GROUP, Ha Noi City (VN)

(21) Appl. No.: 18/924,762

(22) Filed: Oct. 23, 2024

(30) Foreign Application Priority Data
Dec. 26, 2023 (VN) 1-2023-09259

(51) Int. Cl. G01S 7/28; G01S 13/28; G01S 13/78

(52) U.S. Cl. CPC G01S 7/2813; G01S 13/284; G01S 13/784

(57) ABSTRACT

The invention proposes a system to compress reflected signals on a fluctuating noise background applied to active surveillance radar systems. This is a new, simple and effective solution to compress signals before sharing or transmitting to the processing center. Unlike previous systems based on performing compression on each reflected pulse, this transparent proposed system processes reflected regions in the form of a two-dimensional (2D) correlation matrix, combined with the dynamic calculation, automatically accumulates and adapts to changes; the convolution and compression algorithms are simple and effective since they are associated with the characteristics of active radar reflected areas in both frequency and time domains. Thanks to that, the system proposed in this invention provides effective and superior compression performance compared to the proposed systems. Furthermore, the system proposed in the invention is easily deployed on an FPGA high-speed computing platform to suit low-latency real-time monitoring applications or system expansion.

### FIELD OF THE INVENTION

This invention proposes a system compressing active radar reflected signals on a fluctuating noise background. Specifically, it relates to the field of signal processing in active surveillance radar systems.

### BACKGROUND OF THE INVENTION

In active surveillance radar systems including component radars and a processing center, each radar sends out a probe pulse after each pulse of the transmitted shock signal, which hits the objects and returns a reflected signal. The signals reflected from the radars are shared or transmitted to the processing center. In the current context, the transmission of these reflected signals is even more urgent because: when the component radar is subject to electronic warfare, it is necessary to coordinate with neighboring radar sources to identify the noises or targets, and avoid revealing the location when emitting radiation, so need a nearby source to proactively grasp the situation; focus on a key direction or area with many radars.

Active radar reflected signals include both targets and noises (terrain, geophysics, clouds, fake targets, etc.). These noises are all fluctuating and can vary over space and time. Considering the origin, noises can come from objective factors (location, weather, diffusion, radiation, etc.) or subjective factors (jamming devices, signal disruption, simulation, etc.). Based on physical factors, noises can be divided into two types: terrain noises (trapezoidal shape, fixed frequency, location that rarely or slightly changes, needs to be shared or transmitted) and other noises (pulse shape, variable frequency, location that usually changes, no need to share or transmit).

To enhance surveillance capacity and expand active surveillance radar systems, it is necessary to compress the reflected signals of each component radar to eliminate other noise, redundant information and retain important data about the terrain and targets.

Around the world, many compression solutions have been researched, but the subjects of application are text, images, audio, and video data. For radar reflected signals, research has only been conducted recently, focusing on single echo pulse compression (refer to “Digital Signal Processing of Radar Pulse Echoes” by Armin W Doerry, 2020 and “Application of Compressed Sensing to Radar Signals” by Jozef Perd′och, Miroslav Pacek, Zdeněk Matoušek, Stanislava Gažovová, 2023). This approach has limitations as it does not show the correlation between echo pulses in terms of azimuth and range in forming terrain and target information. In addition, the radar reflected signals have variable frequency and appearance time characteristics in both the time and frequency domains, but no solution has yet analyzed signals in both domains. Current compression solutions only operate in one-dimensional (1D) space along the reflected pulse. Furthermore, the intensity of the reflected signal varies with distance from the center of the radar station, so an adaptive filtering threshold is needed; the background terrain information around the radar changes little and thus does not need to be continuously transmitted; and there needs to be a calculation principle to dynamically accumulate terrain background information when changes occur. These factors lead to information discrepancies, excessive transmission channel and processing resource consumption, and non-optimal compression (low Compression Ratio—CR, high Mean Squared Error—MSE, low Peak Signal to Noise Ratio—PSNR, etc.)

To overcome the aforementioned drawbacks, the purpose of this invention is to propose a new system to effectively compress reflected signals on a fluctuating noise background. Furthermore, the system proposed in this invention is designed in a modular, sequential manner to be deployable on accelerated computing platforms, making it suitable for real-time surveillance applications or system expansion.

### SUMMARY OF THE INVENTION

The purpose of the invention is to propose a system to compress reflected signals on a fluctuating noise background, aiming to overcome the disadvantages of recent solutions.

In this invention, the system is implemented through the following blocks:

Data normalization block: The initial radar reflected data in one-dimensional (1D) pulses is fed into the data reception buffer. Here, transformations are performed to create two-dimensional (2D) data packets for later processing. The packets are sequentially arranged according to azimuth and distance.

Dynamic terrain noise filtering block: Here, the initialization, construction and accumulation of topographic maps from the two-dimensional (2D) matrices (azimuth-range) in the data normalization block are performed. The calculation principle is based on dynamic accumulation of each reflected pulse at each azimuth angle, allowing automatic updates of the topographic map background when changes occur. The extent of terrain background change is evaluated for each region and only the changing terrain areas (exceeding the threshold) are sent.

Adaptive spatial noise filtering block: Here, from the two-dimensional (2D) matrices (azimuth-distance) in the data normalization block, transformations and calculations are performed to eliminate the terrain background data by filtering out dynamic noise through range correlation filtering and adaptive spatial filtering to remove other noise and enhance target information.

Reflected signal compression block: Here, the signal is transformed to a time-frequency correlation matrix, and through multi-resolution transformations, the signal characteristics are extracted and represented as a one-dimensional (1D) binary sequence. This data has a significantly reduced size compared to the original data. To increase compression efficiency, a compression method is proposed that replaces identical, frequently occurring binary sequence segments with shorter encoded bit sequences.

Data transmission block: The transmitted data includes cyclic transmitted data (compressed data series after each processing of n azimuth rays) and acyclic (region of geophysical data when there is enough variation). If it is a new connection, all feature data will be sent. Also set a high priority for cyclical data because features change less.

Reception, decompression, and display block: Here, depending on the type of received data, corresponding processing will be performed. If it is terrain data, it will be updated accordingly. If it is compressed data, decompression will be performed step by step, including inverse time-frequency transformation and adding terrain data for display.

### BRIEF DESCRIPTION OF THE DRAWINGS

FIG. 1a: Illustrates the components of active radar reflected signals with noise background fluctuating over time-frequency;

FIG. 1b: Depicts the display on an active radar surveillance screen;

FIG. 2: Shows the functional blocks of the proposed system;

FIG. 3: Illustrates the processing flow and modules of the data normalization block;

FIG. 4: Depicts the processing flow and modules of the dynamic terrain noise filtering block;

FIG. 5a: Illustrates the processing flow and modules of the adaptive spatial noise filtering block;

FIG. 5b: Shows the multi-level trapezoidal probability distribution of the range correlation filter;

FIG. 6: Depicts the processing flow and modules of the feature extraction and compression block; and

FIG. 7: Illustrates the processing flow and modules of the reception, decompression, and display block.

### DETAILED DESCRIPTION OF THE INVENTION

The invention proposes a system to compress reflected signals on a fluctuating noise background, applicable to active surveillance radar systems, described in detail below:

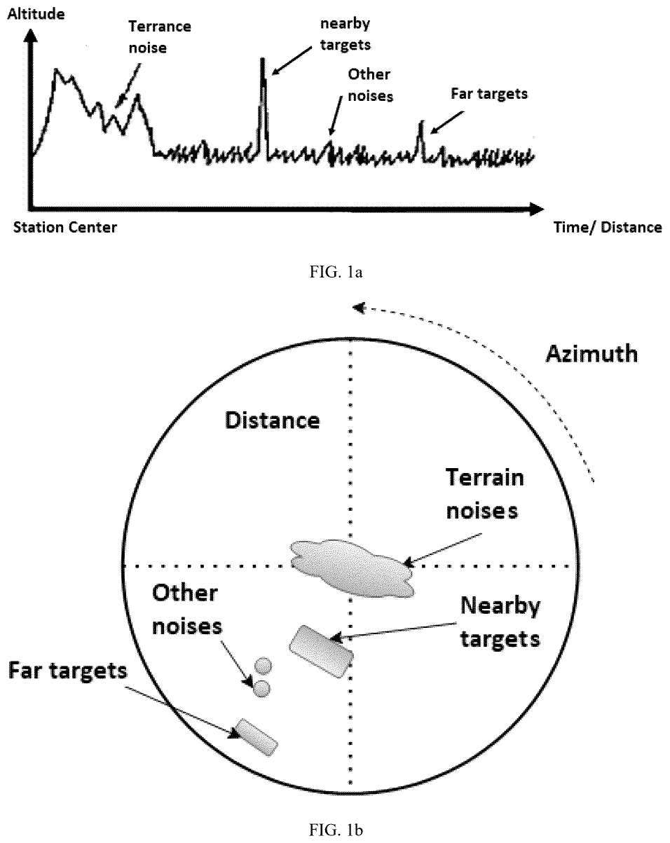

Referring to FIG. 1, the radar reflected signal includes target information and noises information (geographic noises that need to be shared or transmitted; other noises that needs to be removed before sharing or transmission) as shown in FIG. 1a. These pieces of information vary in amplitude and time or range, so when displayed on a radar screen, they appear differently as shown in FIG. 1b.

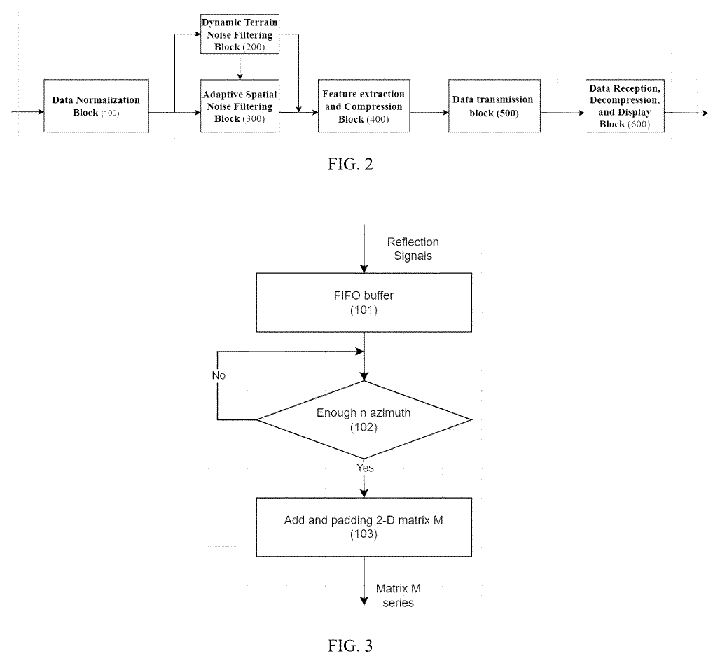

Referring to FIG. 2, the proposed system in this invention includes the following functional blocks:

The specific content of the blocks is as follows:

### Data Normalization Block (100):

Referring to FIG. 3, the reflected signal is received by the buffer module (101), which implements a FIFO (First In First Out) sequential processing mechanism. When there are enough n reflected pulses in azimuth 102 (n can be 8, 16, 32, 64), they are sent to the two-dimensional (2D) matrix creation module (103), with dimensions n×n. Consecutive matrices will cover the entire distance of the reflected pulse. In case the matrix at the end of the reflected does not have sufficient size n, padding will be added with a value of 0. Assuming the length of the reflected signal over distance is m, the number of matrices on a ray is the integer part of

$$\frac{m}{n} + 1.$$

### Dynamic Terrain Noise Filtering Block (200):

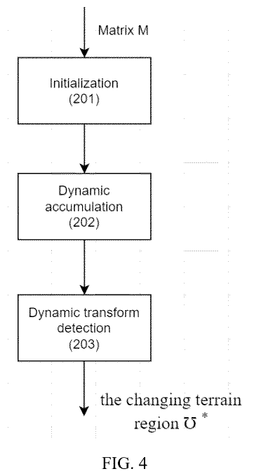

Referring to FIG. 4, the matrices M are the input for the dynamic terrain noise filtering block (200). During the initial startup, it is necessary to initialize the terrain matrix υ_{k×m} 201, in two dimensions (2D), where k is the number of rays covering the full 360° azimuth and m is the length in distance. Next, the dynamic filtering process of the terrain map includes two main tasks: dynamic accumulation and dynamic detection of changing terrain regions.

The dynamic accumulation module (202) is implemented based on the principle that the reflected signal from terrain at a certain distance and azimuth is stable, or in other words, the signal reflected from the terrain across different scans is correlated, while the target signal and other fluctuating noise are unstable, varying with each scanning round, and not correlated. Therefore, when receiving the 2D matrix data, it will be processed based on each azimuth pulse θ as follows:
If the value X_{θi} of the pulse at position i along the distance dimension is greater than the value of the current terrain map threshold Ωᵢ, then retain the pulse value (target or background noise needs to be kept). Considering that the signal amplitude decreases with distance, with higher signals near and lower signals far, the threshold Ωᵢ should be dynamically set according to distance m as follows:

$${Ω}_{i} = ( 1 - \frac{m - i}{m} + ℰ ) {Ω}_{0} ,$$

where ε={0; 1} is the far-range threshold coefficient.
When the value is not larger (possibly terrain noise), update the new value at position i according to the principle:

$${℧}_{θ i \_ new} = {α℧}_{θ i \_ current} + ( 1 - α ) {X}_{θ i}$$

The inertia update coefficient α ranges from [0; 1], the closer to 1, the slower the terrain map updates, for example, if α=0,975, the new value of the terrain map only incorporates 2.5% of the new pulse characteristic, retaining 97.5% of the old value. This means that the radar complete several rotations for the terrain map to stabilize and be less affected by sudden spike values.
This dynamic accumulation method helps automatically update the terrain background when changes occur. The aggregate of regions around 360° of the radar will provide the dynamically accumulated terrain noise data.

The dynamic detection module (203) dynamically detects changes in terrain regions by calculating the deviation of the updated value from the current value at each point in the region. Each region here is represented as a two-dimensional (2D) matrix with an assigned code for differentiation, this code is used to inform the receiver to change the corresponding region. The steps are as follows:
Calculate the change level of region j, denoted as Cej, based on cross-entropy theory using the formula:

$$C {E}_{j} = {\sum }_{n , n} log \{ ( {℧}_{θ i \_ new} - {℧}_{θ i \_ current} ) / {℧}_{θ i \_ current} \}$$

If CEⱼ is greater than the threshold [symbol] _{CE}=[0; 1], the terrain map is considered a major change and needs to be sent for update. This region is called the changing terrain region [symbol] .

### Adaptive Spatial Noise Filtering Block (300):

For other noise with non-fixed frequency characteristics (frequency characteristics), changing pulse shape and positions (time characteristics), processing is required through range correlation filtering and signal transformation into spatial domains of frequency and time to highlight the noise before adaptive threshold processing.

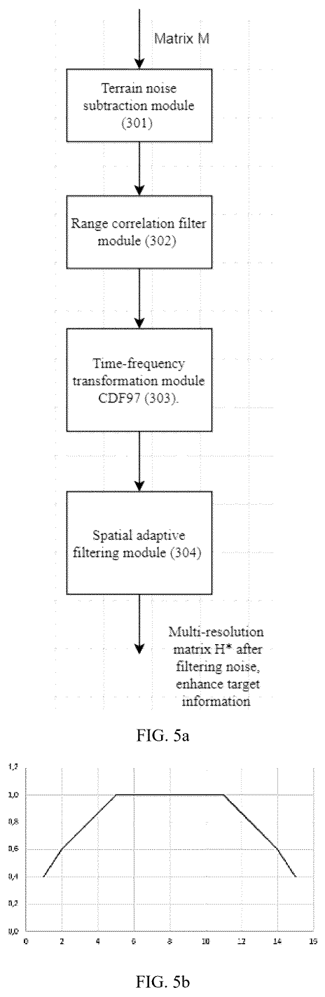

Referring to FIG. 5a, the two-dimensional (2D) matrices, the inputs of the adaptive spatial noise filtering block (300), need to be fed into the terrain noise subtraction module (301) corresponding to the examined region. Next, because the pulse-shaped noise has low distance correlation, it is first processed through the range correlation filter module (302) to reduce the noise amplitude and at the same time, strengthen the target signal. Accordingly, when receiving matrix data M after terrain subtraction, it will be processed based on each azimuth pulse θ as follows:
Convolve with a reference window along the distance direction:
£_{1×n}={μ₁; μ₂; . . . ; μₙ}, with n={4; 8; 16; 32}, μₙ=[0; 1].

The window £_{1×n} is selected in the form of a multi-layer trapezoidal probability distribution, as shown in FIG. 5b, which characterizes the target signal. For example, £_{1×16}={0,4; 0,6; 0,7; 0,8; 0,9; 1,0; 1,0; 1,0; 1,0; 1,0; 1,0; 0,9; 0,8; 0,7; 0,6; 0,4}.
The result of the above convolution is that signal areas with the same intensity distributions similar to the reference will be enhanced, while regions with different distributions from the reference will be attenuated.
The matrices after convolution are processed through the time-frequency transformation module CDF97 (303). Here, the Cohen-Daubechies-Feauveau 97 (CDF97) transform converts the signal into a multi-resolution two-dimensional (2D) matrix (in the form of LL, HL, LH, HH). The number of levels η in CDF97 will affect the degree of edge separation after extraction.
Next, the multi-resolution matrices are passed through the spatial adaptive filtering module (304) to eliminate other random noise, the post-transformed value in each cell (hᵢⱼ) in the multi-resolution matrices, all contains noise information. Noise removal is performed by comparison with a threshold T; the value \tilde{h}ᵢⱼ after the adaptive filter is calculated as follows:

$${\tilde{h}}_{i j} = \{ \begin{matrix}{h}_{ij} + \frac{T ( {e}^{- η} - 1 )}{2 ( {e}^{- η} + 1 )} & if {h}_{ij} \geq T \\ 0 & if {h}_{ij} < T\end{matrix} ,$$

where η is the level number of CDF97.
The set of \tilde{h}ᵢⱼ forms the matrix H*, a multi-resolution matrix that includes data with other random noise removed.

### Feature Extraction and Compression Block (400):

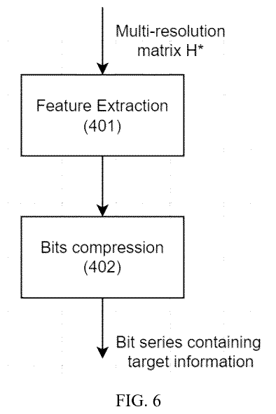

Referring to FIG. 6, the input is the matrix H*. Here, computations are performed to extract data features and compress the byte sequence.

Feature extraction module (401) performs reverse calculation according to the spatial orientation tree to extract features, which are elements with values exceeding the corresponding threshold. Since the CDF97 transform halves the value at each level, the threshold will also be adjusted up or down based on the orientation origin choice, done as follows:
Select the orientation origin O_{(i,j)} as an element of HH (top left corresponds to O_{(0,0)}) or an element of LL (bottom right corresponds to O_{(n-1,n-1)}).
Select the initial threshold [symbol] ₀, which is the integer closest to the maximum value of the level, satisfies [symbol] ₀=2^{p}, p is a positive integer. After each level, set the corresponding threshold [symbol] ₀ according to the principle:

$$= \{ \begin{matrix}{2}^{- η} & if the initial root is {O}_{( n - 1 , n - 1 )} \\ {2}^{η} & if the initial root is {O}_{( 0 , 0 )}\end{matrix}$$

Initialize an empty list of significant cells (LSC) with size n×n in a one-dimensional (1D) format {0}.
Sequentially iterate through all levels of H*. At each level, compare the value of each corresponding cell with the threshold to determine if it is a significant element. If the value is less than ţ₀, set the corresponding bit in the LSC to 0; otherwise, set it to 1. The LSC sequence is significantly smaller than the original M matrix because the matrix values are replaced by a single bit.

Bit Sequence Compression Module (402) will calculate according to the principle of replacing repeated 8-bit sequences with shorter bit sequences as follows:
Pair each 8-bit sequence to create an ASCII character. Add padding with a value of 0 to the beginning. Thus, the LSC bit sequence is represented as a list of ASCII characters (LAC).
Count the frequency of each ASCII character in the LAC to create a list of ordered ASCII characters (LOAC), sorted in descending order of frequency. Also, calculate N as the number of different characters in the LAC string.
To reduce the size, perform the following two actions simultaneously:
Instead of using eight bits to represent an ASCII code, use a maximum of b bits, with b=1+Rounddown (log₂ N), where b is always less than 8.
Create a bit encoding table based on the principle that more frequently occurring characters in the LOAC are replaced by fewer bits. Characters that appear more frequently will be represented by fewer bits. Pack this encoding table as a header before sending the compressed data.
Replace segments in LSC according to the bit encoding table to obtain the compressed data.
Since the echo signal features have similar backgrounds and targets, repeated bits will occur frequently. Therefore, compression using this principle will be effective.

### Data Transmission Block (500):

The transmitted data includes cyclic data (the compressed data sequence after each processing of nnn azimuth beams, including the bit encoding table header) and non-cyclic data (the terrain data region when there is sufficient change). If it's a new connection, all terrain data will be sent. Priority is established for transmitting cyclic data because the terrain changes less frequently.

### Data Reception, Decompression, and Display Block (600):

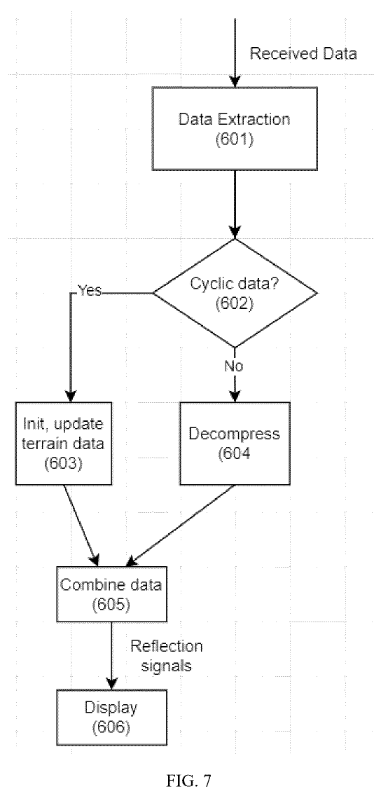

Referring to FIG. 7, the received data will be fed into the Data Extraction Module (601). Here, based on the marked code, the data is classified into two types:
Non-cyclic data (terrain background, changing terrain regions). This data is passed to the Terrain Initialization and Update Module (603).
Cyclic data (bit encoding table and compressed data sequence). This data is passed to the Decompression Module. Here, the processes of the Feature Extraction and Compression Block (400) and the Adaptive Spatial Filtering Block (300) are sequentially reversed to decompress the data. The CDF97 inverse transform is applied to restore the data into matrices containing target information but lacking terrain data.

The two types of data are combined according to the correct azimuth and distance codes in the Data Merging Module (605), before being transmitted to the Display Module (606).

What is claimed is:

1. A system for compressing reflected signals on a fluctuating noise background in active surveillance radar systems, comprising the following blocks:
a data normalization block; performing the following small steps:
reflected signals are received into a buffer module, processed in a FIFO (First In, First Out) manner, when n (n can be 8, 16, 32, 64) azimuthal reflected signals are accumulated, they are sent to a two-dimensional (2D) matrix creation module of size n×n;
if the final reflected pulse matrix does not have enough n samples, padding with zero values is added, if the range length of the reflected signal is m, the number of matrices per beam is the integer part of m/n+1;
a dynamic terrain noise filtering block; performing the following steps:
on initial startup, initialize a two-dimensional (2D) clutter matrix k×m, where k is the number of beams covering 360 degrees azimuth and m is the range length;
a dynamic accumulation module to dynamically accumulate clutter information;
a dynamic detection module to dynamically detect changing areas of the clutter;
an adaptive spatial noise filtering block; performing the following steps:
calculate the threshold Ωi by range Ωi=(1−(m−i)/m+ε)Ω0, with ε={0; 1} the far threshold coefficient;
choose the inertia update coefficient α=[0; 1];
compare the value Xθi of azimuthal pulse θ at position i in the range with the threshold Ωi to determine the update principle _{θi_new}=α_{θi_current}+(1−α)X_{θi}:
a feature extraction and compression block; performing the following steps:
a feature extraction module to separate and store data features after removing clutter and other noise, converting from 2D to 1D format;
a bitstream compression module to further compress 1D feature data by replacing identical 8-bit sequences that repeat many times with shorter bit sequences;
a data reception, decompression, and display block; performing the following steps:
transmit data cyclically (compressed data stream after processing n azimuthal beams, including the bit encoding header) and non-cyclically (clutter data area when there is sufficient change);
send all clutter data when a new connection is established;
prioritize cyclic data transmission since clutter changes less frequently.

2. The system for compressing reflected signals on a fluctuating noise background in active surveillance radar systems according to claim 1, wherein the dynamic detection module of the dynamic terrain noise filtering block performs the following steps:
mark the j-th region being examined by azimuth and range;
set the change threshold _{CE}=[0; 1];
calculate the change level of region j using the formula
$$C {E}_{j} = {\sum }_{n , n} log \{ ( {℧}_{θ i \_ new} - {℧}_{θ i \_ current} ) / {℧}_{θ i \_ current} \} ;$$
compare CEⱼ with CE to identify the changing region to be sent (region *).

3. The system for compressing reflected signals on a fluctuating noise background in active surveillance radar systems according to claim 1, wherein the adaptive spatial noise filtering block performs the following steps:
subtract the corresponding clutter background;
employ a range correlation filtering module to eliminate pulse noise amplitude while enhancing target signals;
employ a CDF97 frequency-time transform module to analyze data in both frequency and time domains;
employ an adaptive spatial filtering module to eliminate other random noise.

4. The system for compressing reflected signals on a fluctuating noise background in active surveillance radar systems according to claim 3, wherein the range correlation filtering module of the adaptive spatial noise filtering block performs the following steps:
select a reference window £_{1×n}={μ₁; μ₂; . . . ; μₙ}, with n={4; 8; 16; 32}, μₙ= [0; 1], multi-level trapezoidal probability distribution;
convolve each pulse in the region.

5. The system for compressing reflected signals on a fluctuating noise background in active surveillance radar systems according to claim 3, wherein the CDF97 frequency-time transform module of the feature extraction and compression block performs the following steps:
choose the transformation level of CDF97 and perform the transformation to achieve multi-resolution format;
set the spatial adaptive threshold T;
compare each hij value in the multi-resolution matrix with T to calculate the new value \tilde{h}ᵢⱼ.

6. The system for compressing reflected signals on a fluctuating noise background in active surveillance radar systems according to claim 1, wherein the feature extraction module of the feature extraction and compression block performs the following small steps:
select the orientation root in HH or LL in the multi-resolution matrix;
set the initial threshold ţ_0 as the nearest integer to the highest level value satisfying ţ₀=2^{p}, p is a positive integer;
after each level, set the corresponding threshold [symbol] _{η} according to [symbol] ₀ 2^{-η} if the initial root is in HH, [symbol] ₀2^{η} if the initial root is in LL;
initialize a one-dimensional (1D) feature element list LSC {0}, size n×n;
sequentially examine the values in the cells from the orientation root, compare with the threshold ţ_{η} to determine the feature value, and set the corresponding bit to 1.

7. The system for compressing reflected signals on a fluctuating noise background in active surveillance radar systems according to claim 1, wherein the bitstream compression module of the feature extraction and compression block performs the following small steps:
pair each 8-bit sequence to form an ASCII character in LSC into an ASCII character list LAC, add padding with zero values at the beginning;
count the frequency of each ASCII character in LAC into an ordered ASCII character list (sorted in descending order of frequency) LOAC;
calculate the maximum number of bits b to represent LOAC, with b=1+Rounddown (log₂ N), b is always less than 8;
establish the bit encoding table in sequence, with characters appearing frequently in LOAC being replaced with fewer bits;
replace segments in LSC according to the bit encoding table to obtain the compressed bit sequence.
